(19) United States
(12) Patent Application Publication
(10) Pub. No.: US 2026/0268908 A1
(43) Pub. Date: Sep. 10, 2026

(54) SYSTEM

(71) Applicant: SOFTBANK GROUP CORP., Tokyo (JP)

(72) Inventor: Haruki TERAKADO, Tokyo (JP)

(73) Assignee: SOFTBANK GROUP CORP., Tokyo (JP)

(21) Appl. No.: 19/555,035

(22) Filed: Mar. 3, 2026

Related U.S. Application Data
(60) Provisional application No. 63/766,557, filed on Mar. 4, 2025.

(51) Int. Cl. G10L 15/22; G06F 40/30; G06N 3/042; G06N 3/0475; G10L 13/027; G10L 13/033; G10L 13/047; G10L 15/16; G10L 15/30; G10L 21/0208; G10L 25/63

(52) U.S. Cl. CPC G10L 15/22; G06F 40/30; G06N 3/042; G06N 3/0475; G10L 13/027; G10L 13/033; G10L 13/047; G10L 15/16; G10L 15/30; G10L 21/0208; G10L 25/63

(57) ABSTRACT

A system that streamlines smartphone technical support, comprising a speech recognition unit, a generative AI unit, a speech synthesis unit, and an interaction log recording unit is disclosed. The speech recognition unit converts the user's voice into text in real time. The generative AI unit analyzes this text and generates an appropriate solution. The speech synthesis unit conveys the generated solution to the user via voice. The interaction log recording unit records all interactions. This enables 24/7 voice support with no wait times, enhancing user convenience while streamlining support operations. Furthermore, log data can be leveraged to predict future issues and implement preemptive countermeasures. The system learns user accents and speech patterns, improving recognition accuracy over time.

### CROSS-REFERENCE TO RELATED APPLICATION

This application claims priority under 35 U.S.C. § 119 to U.S. Provisional Patent Application No. 63/766,557, filed on Mar. 4, 2025, the entire contents of which are incorporated herein by reference.

### BACKGROUND

### Technical Field

The present disclosure relates to a system.

### Related Art

Japanese Patent Application Publication Laid-Open (JP-A) No. 2022-180282 discloses a persona chatbot control method performed by at least one processor, comprising: a step of receiving a user utterance; a step of adding to the user utterance a prompt containing a description of the chatbot's persona and related instructions; a step of encoding the prompt; and a step of inputting the encoded prompt into a language model to generate a chatbot utterance in response to the user utterance.

### SUMMARY

Sytem and method for eliminating the long waiting times and inconvenience faced by users in smartphone technical support is disclosed. In conventional support systems, users often had to wait a long time to receive support. Furthermore, text-based chat support presented issues such as the effort required for input and communication inefficiencies. Even when providing voice support, the accuracy of voice recognition was low, sometimes failing to accurately understand the user's intent.

The disclosures enables 24/7, year-round voice support with zero wait times by leveraging generative AI and voice input/output AI. By accurately transcribing user inquiries using speech recognition technology and having generative AI swiftly propose solutions, users can immediately receive instructions for problem resolution.

Furthermore, automatically recording interaction logs allows human support staff to intervene when necessary, efficiently following up by referencing past exchanges. This approach enhances user convenience while streamlining support operations.

As a means to solve the problem, a system comprising a speech recognition unit, a generative AI unit, a speech synthesis unit, and an interaction log recording unit. The speech recognition unit has the capability to convert voice input from users into text data in real time, enabling the accurate transcription of user inquiries is proposed. The generative AI unit analyzes the text data obtained by the speech recognition unit and rapidly generates solutions based on the user's inquiry content. This generative AI unit utilizes advanced natural language processing technology to accurately understand the user's intent and present appropriate solutions.

Furthermore, the speech synthesis unit converts the solutions generated by the generative AI unit into audio data and provides voice responses to the user. This allows users to receive support directly via voice without needing to read text. The interaction log recording unit automatically records the user's inquiry content and the response content generated by the generative AI unit. When necessary, it enables support staff to quickly reference past interactions when intervening. This enhances user convenience while improving support operation efficiency. This enhances user convenience while improving the efficiency of support operations.

### BRIEF DESCRIPTION OF THE DRAWINGS

FIG. 1 is a conceptual diagram showing an example configuration of the data processing system according to the first embodiment.

FIG. 2 is a conceptual diagram showing an example of key functional components of the data processing device and smart device according to the first embodiment.

FIG. 3 is a conceptual diagram showing an example configuration of the data processing system according to the second embodiment.

FIG. 4 is a conceptual diagram showing an example of the main functions of the data processing device and smart glasses according to the second embodiment.

FIG. 5 is a conceptual diagram showing an example configuration of a data processing system according to a third embodiment.

FIG. 6 is a conceptual diagram showing an example of the main functions of the data processing device and headset-type terminal according to the third embodiment.

FIG. 7 is a conceptual diagram showing an example configuration of a data processing system according to the fourth embodiment.

FIG. 8 is a conceptual diagram showing an example of the main functions of the data processing device and robot according to the fourth embodiment.

FIG. 9 shows an emotion map onto which multiple emotions are mapped.

FIG. 10 shows an emotion map onto which multiple emotions are mapped.

### DETAILED DESCRIPTION

The following describes an example embodiment of a system according to the present disclosure with reference to the accompanying drawings.

First, the terminology used in the following description is explained.

In the following embodiments, a processor (hereinafter simply referred to as a "processor") may be a single arithmetic unit or a combination of multiple arithmetic units. Furthermore, the processor may be a single type of arithmetic unit or a combination of multiple types of arithmetic units. Examples of processing units include a CPU (Central Processing Unit), a GPU (Graphics Processing Unit), a GPGPU (General-Purpose Computing on Graphics Processing Units), an APU (Accelerated Processing Unit), and the like.

In the following embodiments, signed RAM (Random Access Memory) is a memory where information is temporarily stored and is used as working memory by the processor.

In the following embodiments, the encoded storage is one or more non-volatile storage devices that store various programs and various parameters, etc. Examples of non-volatile storage devices include flash memory (SSD (Solid State Drive)), magnetic disks (e.g., hard disk), or magnetic tape.

In the following embodiments, the coded communication interface is an interface including a communication processor and an antenna, etc. The communication interface governs communication between multiple computers. Examples of communication standards applicable to the communication interface include wireless communication standards such as 5G (5th Generation Mobile Communication System), Wi-Fi (registered trademark), or Bluetooth (registered trademark).

In the following embodiments, "A and/or B" is synonymous with "at least one of A and B." That is, "A and/or B" may mean A alone, B alone, or a combination of A and B. Furthermore, in this specification, when three or more items are connected using "and/or," the same concept applies as for "A and/or B".

### First Embodiment

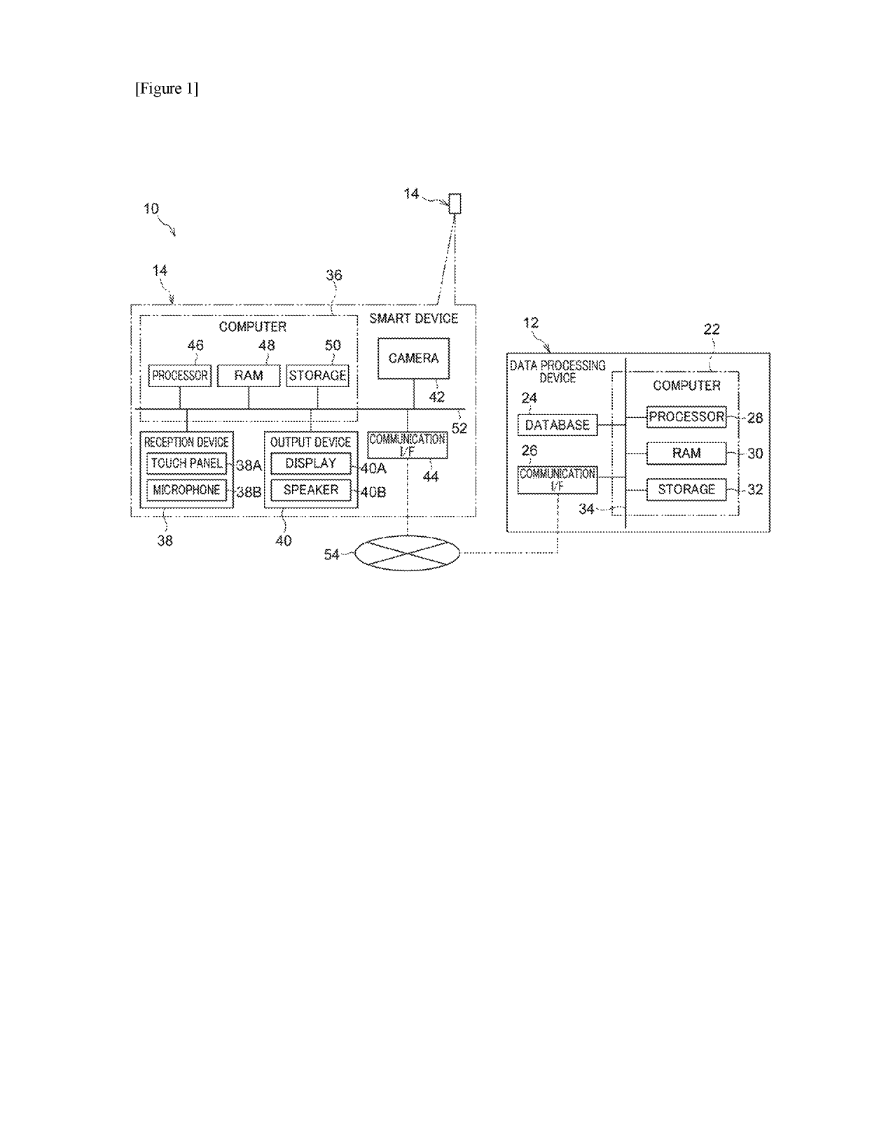

FIG. 1 shows an example configuration of the data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52. The reception device 38, output device 40, and camera 42 are also connected to the bus 52.

The reception device 38 includes a touch panel 38A and a microphone 38B, among other components, and receives user input. The touch panel 38A receives user input via contact with an input device (e.g., a pen or finger) by detecting such contact. The microphone 38B receives voice-based user input by detecting the user's voice. The control unit 46A transmits data indicating the user input received via the touch panel 38A and microphone 38B to the data processing unit 12. Within the data processing unit 12, the specific processing unit 290 acquires the data indicating the user input.

The output device 40 includes a display 40A and a speaker 40B, among others. It presents data to the user 20 by outputting it in a form perceptible to the user 20 (e.g., voice and/or text). The display 40A displays visual information such as text and images according to instructions from the processor 46. The speaker 40B outputs voice according to instructions from the processor 46. The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor.

The communication interface 44 is connected to the network 54. The communication interfaces 44 and 26 manage the exchange of various information between processor 46 and processor 28 via network 54.

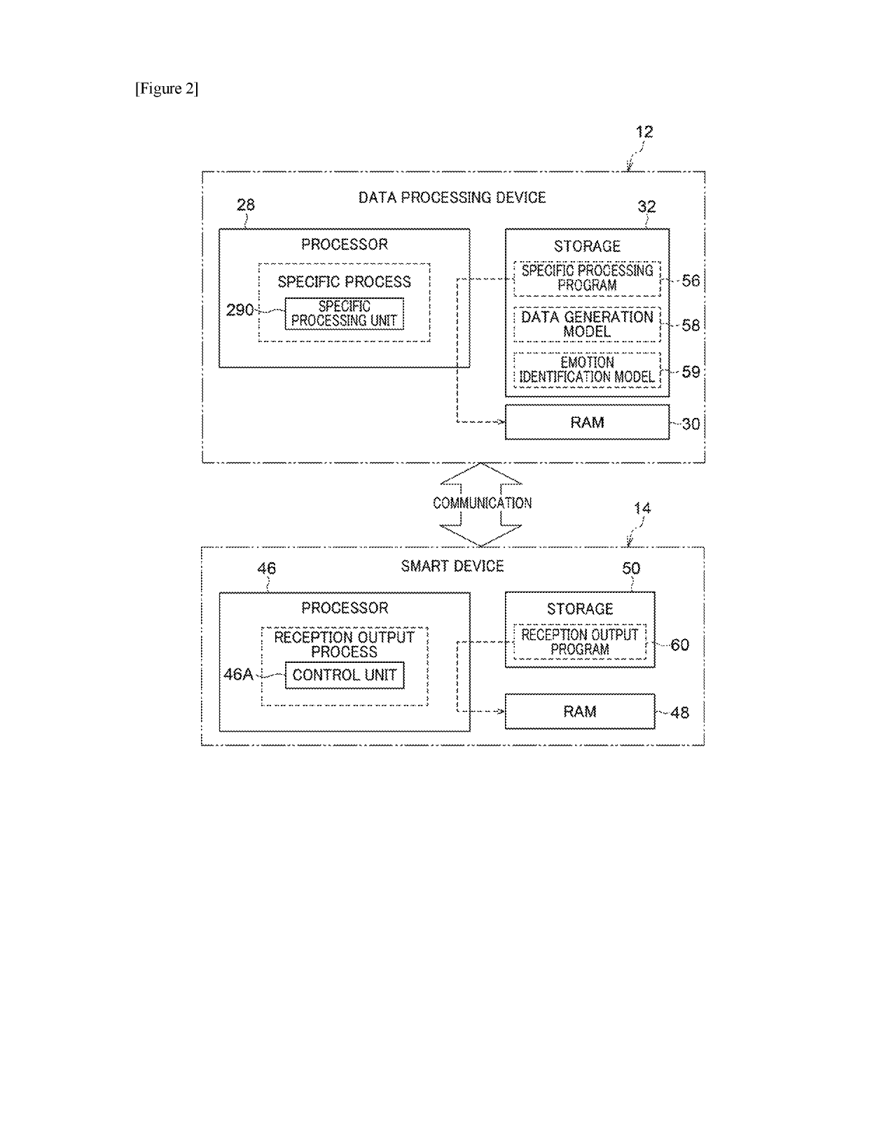

FIG. 2 shows an example of the main functions of the data processing device 12 and the smart device 14.

As shown in FIG. 2, specific processing is performed by processor 28 in data processing device 12. Specific processing program 56 is stored in storage 32. Specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

The smart device 14 performs reception output processing via the processor 46. The reception output program 60 is stored in the storage 50. The reception output program 60 is used in conjunction with the specific processing program 56 by the data processing system 10. The processor 46 reads the reception output program 60 from the storage 50 and executes the read reception output program 60 on the RAM 48. The specific processing is performed by the processor 46 operating as a control unit 46A according to the specific processing program 60 executed on the RAM 48. Note that the smart device 14 may also have data generation models and emotion identification models similar to the data generation model 58 and emotion identification model 59, and may perform processing similar to that of the specific processing unit 290 using these models. The reception output processing is realized by the processor 46 operating as the control unit 46A according to the reception output program 60 executed on the RAM 48.

Other devices besides the data processing device 12 may also have the data generation model 58. For example, a server device (e.g., a generation server) may have the data generation model 58. In this case, the data processing device 12 communicates with the server device having the data generation model 58 to obtain processing results (such as prediction results) obtained using the data generation model 58. Furthermore, the data processing device 12 may be the server device itself, or it may be a terminal device owned by a user (e.g., a mobile phone, robot, home appliance, etc.). Next, an example of processing by the data processing system 10 according to the first embodiment will be described.

### Example 1

The flow of the specific processing in Example 1 is described below. The components of the system described below are implemented by the data processing device 12 and the smart device 14. The data processing device 12 is referred to as the "server," and the smart device 14 is referred to as the "terminal."

### Implementation Examples for Carrying Out the Invention

The embodiment for implementing the present invention is described in further detail below. This system is constructed using a server and a terminal, with the functions of each part executed on their respective devices.

First, the speech recognition unit is described. This unit is implemented on the terminal and converts speech input by the user via a terminal such as a smartphone or tablet into text data in real time. The speech recognition unit utilizes the latest speech recognition technology, enabling high-accuracy speech recognition even in noisy environments. For example, if a user says, "My smartphone battery dies quickly," this speech recognition unit accurately transcribes the speech into text and sends it to the server. Furthermore, the speech recognition unit has the capability to learn the user's accent and speech patterns, improving recognition accuracy over time.

Next, the generative AI unit is implemented on the server. This unit receives text data sent from the terminal and analyzes the user's inquiry content. The generative AI unit utilizes natural language processing technology to accurately understand the user's intent and generate appropriate solutions. For example, regarding battery issues, it can provide concrete and practical solutions such as methods to change settings to reduce battery drain, procedures to stop unnecessary applications, and criteria for determining whether battery replacement is necessary. Furthermore, the generative AI unit learns from past inquiry data to build a knowledge base enabling rapid responses to similar problems.

The speech synthesis unit is also implemented on the server. This unit converts solutions generated by the generative AI unit into audio data. The speech synthesis unit can generate natural, easy-to-understand speech, clearly conveying solutions to the user. For example, if the generated solution is "Please turn on Battery Saver from the settings menu," the speech synthesis unit conveys this to the user in smooth speech. The speech synthesis unit also has the capability to adjust voice tone and speed according to user preferences, providing a more personalized experience.

The response log recording unit is implemented on the server. This unit automatically records logs containing the user's inquiry content, the response content generated by the generative AI unit, and the voice data from the speech synthesis unit. This log is referenced later when human support staff intervene. For example, if a user inquiries about the same issue again, referring to past logs enables a swift and efficient response. The response log recording unit also has the capability to analyze log data and provide feedback to improve support quality.

In this way, the present invention enables the provision of 24/7, 365-day voice-based technical support without wait times by combining a server and terminals. This enhances user convenience while also improving the efficiency of support operations. Furthermore, the entire system is designed to be scalable, allowing flexible adaptation to increase in the number of users.

### System Configuration

The system according to this embodiment comprises a speech recognition unit, a generative AI unit, a speech synthesis unit, and a response log recording unit. The speech recognition unit has the function of converting speech uttered by a user via a terminal such as a smartphone or tablet into text data in real time. This unit utilizes the latest speech recognition technology. For example, if a user says, "My smartphone screen is frozen and won't respond," it accurately transcribes this speech into text and sends it to the server. The speech recognition unit also learns the user's accent and speech patterns, improving recognition accuracy over time. Furthermore, it can recognize speech with high accuracy even in noisy environments, enabling precise recognition even in noisy locations such as trains or cafes. The voice recognition unit also understands the user's spoken content based on context and possesses the ability to interpret ambiguous expressions.

The generative AI unit is implemented on the server. It receives text data sent from the speech recognition unit and analyzes the user's inquiry. This unit utilizes natural language processing technology to accurately understand the user's intent and generate appropriate solutions. For example, for a screen freeze issue, it can provide concrete and practical solutions such as methods to force-close the application, device restart procedures, or how to check for system updates. Furthermore, the Generative AI Unit learns from past inquiry data to build a knowledge base for rapid response to similar issues. Specific examples of prompt sentences fed to the Generative AI include: "Please suggest solutions when a user reports a screen freeze" and "Please advise on handling rapid battery drain."

The speech synthesis unit converts solutions generated by the generative AI unit into audio data. This unit can generate natural, easy-to-understand speech, clearly conveying solutions to users. For example, if the generated solution is "Force close the application from the settings menu," the speech synthesis unit delivers this to the user in smooth, natural-sounding speech. The speech synthesis unit also features the ability to adjust voice tone and speed according to user preferences, providing a more personalized experience. Furthermore, the speech synthesis unit supports multilingual capabilities to enable responses in different languages. For example, it can provide voice responses tailored to the user's language, such as English, Chinese, or Spanish.

The response log recording unit automatically records logs containing the user's inquiry content, the response content generated by the generative AI unit, and the voice data from the voice synthesis unit. This unit is referenced when human support staff intervene later. For example, if a user inquires about the same issue again, referencing past logs enables a swift and efficient response. The response log recording unit also has the capability to analyze log data and provide feedback to improve support quality. Furthermore, based on the user's inquiry history, the response log recording unit can provide data to predict future issues and implement countermeasures proactively. In this way, the system according to this embodiment enhances user convenience while improving the efficiency of support operations.

### Implementation Steps

### Step 1: Acquiring Voice Input

The user performs voice input using a terminal such as a smartphone or tablet. In this step, the user verbally describes the problem requiring support. For example, the user states, "My smartphone battery drains quickly." This voice input is processed in real time by the voice recognition unit implemented on the terminal.

### Step 2: Speech Recognition and Text Conversion

The speech recognition unit converts the user's voice into text data in real time. This unit can recognize speech with high accuracy even in noisy environments. For example, accurate recognition is possible even in noisy places like trains or cafes. The speech recognition unit has the capability to learn the user's accent and speech patterns, improving recognition accuracy over time.

### Step 3: Analysis and Solution Generation by Generative AI

The text data obtained by the speech recognition unit is sent to the server and analyzed by the generative AI unit. This AI unit utilizes natural language processing technology to accurately understand the user's intent and generate appropriate solutions. For instance, regarding battery issues, it can provide concrete and practical solutions such as methods to change settings to reduce battery drain, procedures to stop unnecessary applications, and criteria for determining whether battery replacement is necessary. Examples of prompts fed to the generative AI include: "Please suggest solutions when a user reports rapid battery drain" or "Please provide troubleshooting steps for screen freeze issues."

### Step 4: Response via Text-to-Speech

Solutions generated by the generative AI unit are converted into audio data by the speech synthesis unit. This unit can generate natural, easy-to-understand speech, clearly conveying solutions to the user. For example, if the generated solution is "Please enable Battery Saver from the settings menu," the speech synthesis unit delivers this to the user in smooth, natural-sounding speech. The speech synthesis unit also features the ability to adjust voice tone and speed according to user preferences, providing a more personalized experience.

### Step 5: Recording and Analyzing Interaction Logs

The interaction log recording unit automatically records logs containing the user's inquiry content, the response content generated by the generative AI unit, and the voice data produced by the voice synthesis unit. This log is referenced when human support staff intervene later. For example, if a user inquiries about the same issue again, referring to past logs enables a swift and efficient response. The interaction log recording unit also analyzes log data and provides feedback to improve support quality. Furthermore, based on the user's inquiry history, the interaction log recording unit can predict future issues and provide data to enable proactive countermeasures.

### Specific Use Cases

For example, suppose a user is using a smartphone when the Wi-Fi connection suddenly becomes unstable, preventing internet access. In this case, the user can utilize the system of the present invention to request support via voice. The user speaks into the device, "I can't connect to Wi-Fi." This voice is converted into text data in real time by the voice recognition unit implemented in the device.

The voice recognition unit can recognize speech with high accuracy even in noisy environments. It learns the user's accent and speech patterns, improving recognition accuracy over time. The converted text data is sent to the server and analyzed by the generative AI unit.

The Generative AI Department leverages natural language processing technology to accurately understand user intent and generate appropriate solutions. For Wi-Fi connection issues, it can provide concrete and practical solutions such as router restart procedures, methods to verify Wi-Fi settings, network rescan methods, and even device network settings reset procedures. Examples of prompts fed to the generative AI include: "Please suggest solutions when a user reports Wi-Fi connection issues" or "Please advise on troubleshooting steps when internet connectivity is unstable."

The generated solutions are converted into audio data by the speech synthesis unit. This unit can produce natural, easy-to-understand speech, clearly conveying the solutions to the user. For example, if the generated solution is "Restart your router and try connecting again," the speech synthesis unit conveys this to the user in smooth speech. The speech synthesis unit also features the ability to adjust voice tone and speed according to user preferences, providing a more personalized experience.

The response log recording unit automatically records logs containing the user's inquiry content, the response content generated by the generative AI unit, and the voice data from the speech synthesis unit. This log is referenced when human support staff intervene later. For example, if a user inquiries about the same issue again, referring to past logs enables a quick and efficient response. The response log recording unit also analyzes log data and provides feedback to improve support quality. Furthermore, based on the user's inquiry history, the response log recording unit can predict future issues and provide data to implement countermeasures proactively. In this way, the system of the present invention enhances user convenience while improving the efficiency of support operations.

### Application Example 1

The flow of specific processing in Application Example 1 is described below. The components of the system described below are implemented by the data processing device 12 and the smart device 14. The data processing device 12 is referred to as the "server," and the smart device 14 is referred to as the "terminal."

### Implementation Examples for the Present Invention

The embodiment for implementing the present invention is described in further detail below. This system aims to provide rapid and appropriate support via voice for everyday problems faced by elderly individuals and caregivers in nursing facilities or home care settings. The system comprises a voice recognition unit, a generative AI unit, a voice synthesis unit, and a response log recording unit, with each unit operating in coordination.

First, the speech recognition unit has the capability to convert user-spoken audio into text data in real time. This unit is designed to handle noisy environments and speech patterns characteristic of the elderly, enabling accurate speech recognition even in environments such as rooms with televisions on or where multiple people are speaking. The speech recognition unit utilizes the latest speech recognition technology and has the capability to learn the user's accent and speech patterns, improving recognition accuracy over time. For example, if a user says, "Please tell me when to take today's medication," this speech is accurately converted to text and sent to the server. Furthermore, the speech recognition unit has the ability to understand the user's utterance based on context and interpret ambiguous expressions.

Next, the generative AI unit receives the text data sent from the speech recognition unit, understands the user's intent, and generates an appropriate solution. This AI unit utilizes natural language processing technology to analyze the user's inquiry. For example, when confirming medication times, the system references the pre-registered schedule and generates specific instructions such as "Please take your next medication at 2:00 PM." Additionally, when a user reports feeling unwell, the system instructs them to "Please take your temperature with a thermometer" and, if necessary, has the capability to notify medical staff. Examples of prompts fed to the generative AI include: "Generate a response when a user asks about medication timing" or "Suggest countermeasures when high temperature is reported." Furthermore, the generative AI unit learns from past inquiry data to build a knowledge base enabling swift responses to similar issues.

The speech synthesis unit converts solutions generated by the generative AI unit into audio data. This unit can generate natural, easy-to-understand speech, clearly conveying solutions to the user. For example, if the generated solution is "Please take your next medication at 2 PM," the speech synthesis unit delivers this to the user in smooth speech. The speech synthesis unit also has the capability to adjust voice tone and speed according to user preferences, providing a more personalized experience. Furthermore, the speech synthesis unit has multilingual support capabilities to enable responses in different languages. For example, it can provide voice responses tailored to the user's language, such as English, Chinese, or Spanish.

The response log recording unit automatically records logs containing the user's inquiry content, the response content generated by the AI generation unit, and the voice data generated by the voice synthesis unit. This log is stored for later reference by care staff. For example, if a user inquiries about the same issue again, referring to past logs enables a quick and efficient response. The response log recording unit also has the function of analyzing log data and providing feedback to improve the quality of care. Furthermore, the response log recording unit can provide data to predict future issues based on the user's inquiry history and enable proactive countermeasures. In this way, the system of the present invention improves convenience for the elderly in the care field while also enhancing the efficiency of care operations. Through voice-based support, it facilitates communication in care settings and reduces the burden on caregivers.

### System Configuration

The system according to this embodiment comprises a speech recognition unit, a generative AI unit, a speech synthesis unit, and an interaction log recording unit. The speech recognition unit has the function of converting voice input from elderly individuals or caregivers into text data in real time. This unit is designed to handle noisy environments and speech patterns characteristic of elderly individuals. For example, it can accurately recognize speech even in rooms with televisions on or in environments where multiple people are speaking. The speech recognition unit utilizes the latest speech recognition technology and has the capability to learn the user's accent and speech patterns, improving recognition accuracy over time. Furthermore, the speech recognition unit has the ability to understand the user's utterances based on context and interpret ambiguous expressions. For example, if a user says, "Please tell me when to take today's medicine," this speech is accurately transcribed into text and sent to the server.

The generative AI unit receives text data sent from the speech recognition unit, understands the user's intent, and generates an appropriate solution. This AI unit utilizes natural language processing technology to analyze the user's inquiry. For example, when confirming medication times, the system references a pre-registered schedule and generates specific instructions like "Please take your next medication at 2 PM." Additionally, when responding to reports of feeling unwell, the system instructs the user to "Please take your temperature with a thermometer" and can notify medical staff if necessary. Specific examples of prompts fed to the generative AI include: "Generate a response when a user asks about medication timing" or "Suggest a course of action when a high temperature is reported." Furthermore, the generative AI unit learns from past inquiry data to build a knowledge base enabling swift responses to similar issues.

The speech synthesis unit converts solutions generated by the generative AI unit into audio data. This unit can generate natural, easy-to-understand speech, clearly conveying solutions to the user. For example, if the generated solution is "Please take your next medication at 2 PM," the speech synthesis unit conveys this to the user in smooth speech. The speech synthesis unit also adjusts voice tone and speed according to user preferences, providing a more personalized experience. Furthermore, the speech synthesis unit has multilingual support capabilities to enable responses in different languages. For example, it can provide voice responses tailored to the user's language, such as English, Chinese, or Spanish.

The response log recording unit automatically records logs containing the user's inquiry content, the response content generated by the generative AI unit, and the voice data from the voice synthesis unit. This log is stored for later reference by care staff. For example, if a user inquiries about the same issue again, referring to past logs enables a quick and efficient response. The response log recording unit also has the capability to analyze log data and provide feedback to improve the quality of care. Furthermore, the response log recording unit can provide data to predict future issues based on the user's inquiry history and enable proactive countermeasures. In this way, the system according to this embodiment enhances the convenience of elderly individuals in the care field while also improving the efficiency of care operations. Through voice-based support, it facilitates communication in care settings and reduces the burden on caregivers.

### Implementation Steps

### Step 1: Acquiring Voice Input

The elderly person or caregiver requests support by speaking to the system. For example, they input specific requests vocally, such as "Please tell me when to take today's medication" or "I feel like my temperature is high." This voice input is processed in real time by the voice recognition unit implemented in the terminal.

### Step 2: Speech Recognition and Text Conversion

The speech recognition unit converts input speech into text data with high accuracy. This unit is designed to handle noisy environments and speech patterns characteristic of elderly individuals, enabling accurate speech recognition even in environments such as rooms with televisions on or where multiple people are speaking.

### Step 3: Analysis and Solution Generation by Generative AI

The text data obtained by the speech recognition unit is sent to the server and analyzed by the generative AI unit. This AI unit utilizes natural language processing technology to accurately understand the user's intent and generate appropriate solutions. For example, when confirming medication times, the system references a pre-registered schedule and generates specific instructions such as "Please take your next medication at 2:00 PM." Examples of prompt sentences fed to the generative AI include: "Generate a response when a user asks about medication times" or "Suggest countermeasures when a high body temperature is reported."

### Step 4: Response via Text-to-Speech

The generated solution is converted into audio data by the speech synthesis unit and clearly communicated to the elderly or their caregivers. The speech synthesis unit can generate easy-to-understand speech, delivering instructions like "Please take your next medication at 2 PM" in a smooth voice. Furthermore, it can adjust the tone and speed of the voice to match the user's preferences, providing a more personalized experience.

### Step 5: Recording and Analyzing Interaction Logs

The interaction log recording unit automatically records all exchanges for later reference by care staff. This log includes the user's inquiry content, the response content generated by the generative AI unit, and the audio data produced by the speech synthesis unit. This enables care staff to develop more effective care plans based on past. Analyzing the log data also provides feedback to enhance the quality of care.

### Specific Use Cases

For example, consider a scenario where an elderly person in a care facility utilizes the present system for daily health management. When the elderly person wants to confirm their morning medication time, they ask the system, "Please tell me when to take my medicine today." This voice input is converted into text data in real time by the voice recognition unit. The voice recognition unit is designed to accurately recognize speech, even in the presence of facility noise and the unique speech patterns characteristic of elderly individuals.

The converted text data is sent to the generative AI unit for analysis of the user's intent. The generative AI unit utilizes natural language processing technology to reference pre-registered medication schedules and generate specific instructions such as "Please take your next medication at 8:00 AM." Specific examples of prompt sentences fed to the generative AI include "Generate a response when the user asks about medication times" or "Tell me the next medication time based on the medication schedule."

The generated instructions are converted into audio data by the speech synthesis unit and clearly communicated to the elderly user. The speech synthesis unit can generate easy-to-understand speech, delivering instructions like "Please take your next medication at 8:00 AM" in a smooth voice. Furthermore, the tone and speed of the speech can be adjusted to the elderly user's preferences, providing a more personalized experience.

The interaction log recording unit automatically records all exchanges for later reference by care staff. This log includes the elderly person's inquiry content, the response content generated by the generative AI unit, and the voice data from the voice synthesis unit. This enables care staff to develop more effective care plans based on past interactions. Analyzing the log data also provides feedback to improve the quality of care.

Thus, the system of the present invention enhances the convenience of elderly individuals in care facilities while also improving the efficiency of care operations. Through voice-based support, it facilitates communication in care settings and reduces the burden on caregivers.

The specific processing unit 290 transmits the results of the specific processing to the smart device 14. On the smart device 14, the control unit 46A instructs the output device 40 to output the results of the specific processing. The microphone 38B acquires audio indicating user input regarding the results of the specific processing. The control unit 46A transmits the audio data indicating the user input acquired by the microphone 38B to the data processing unit 12. At the data processing unit 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 is input with a prompt containing instructions, and also with inference data such as audio data indicating audio, text data indicating text, and image data indicating images (e.g., still image data or video data). The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), and recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart device 14.

### Second Embodiment

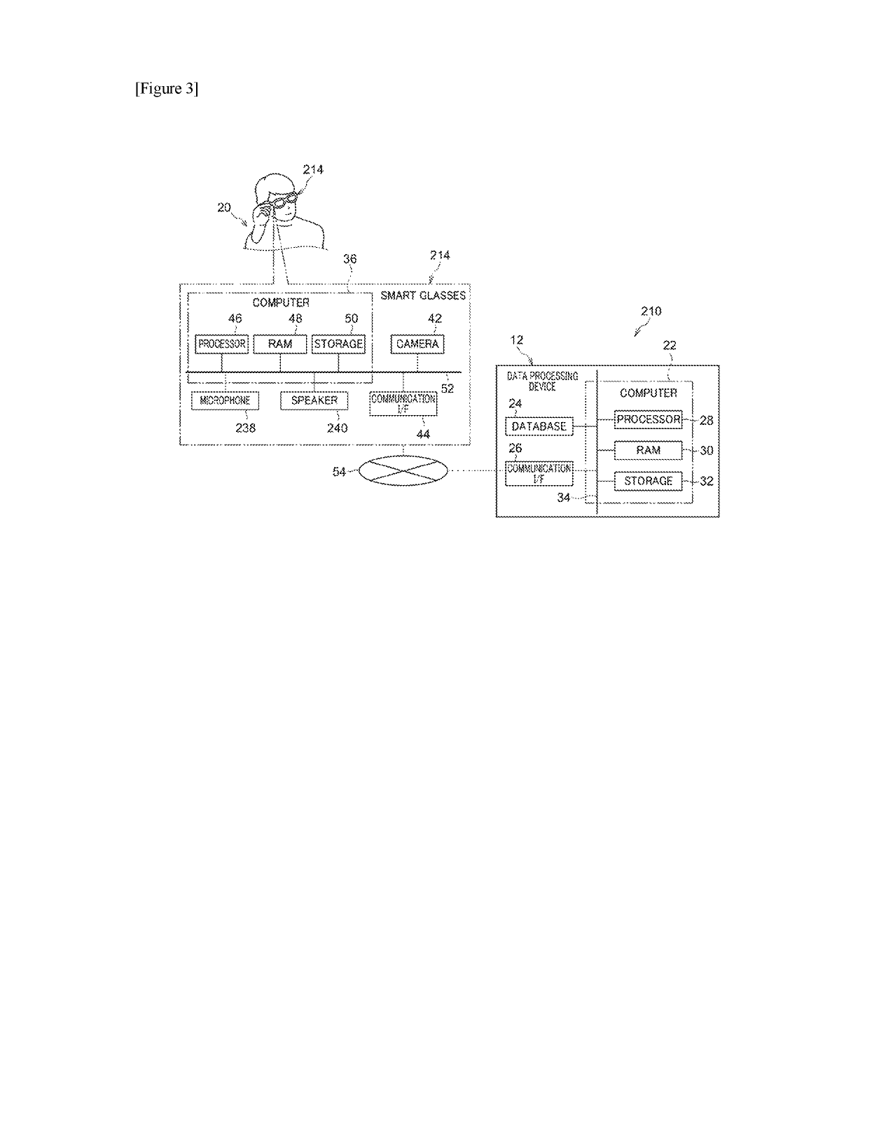

FIG. 3 shows an example configuration of the data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart glasses 214 include a computer 36, a microphone 238, a speaker 240, a camera 42, and a communication I/F 44. The computer 36 includes a processor 46, RAM 48, and storage 50. Processor 46, RAM 48, and storage 50 are connected to bus 52. Microphone 238, speaker 240, and camera 42 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

Camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

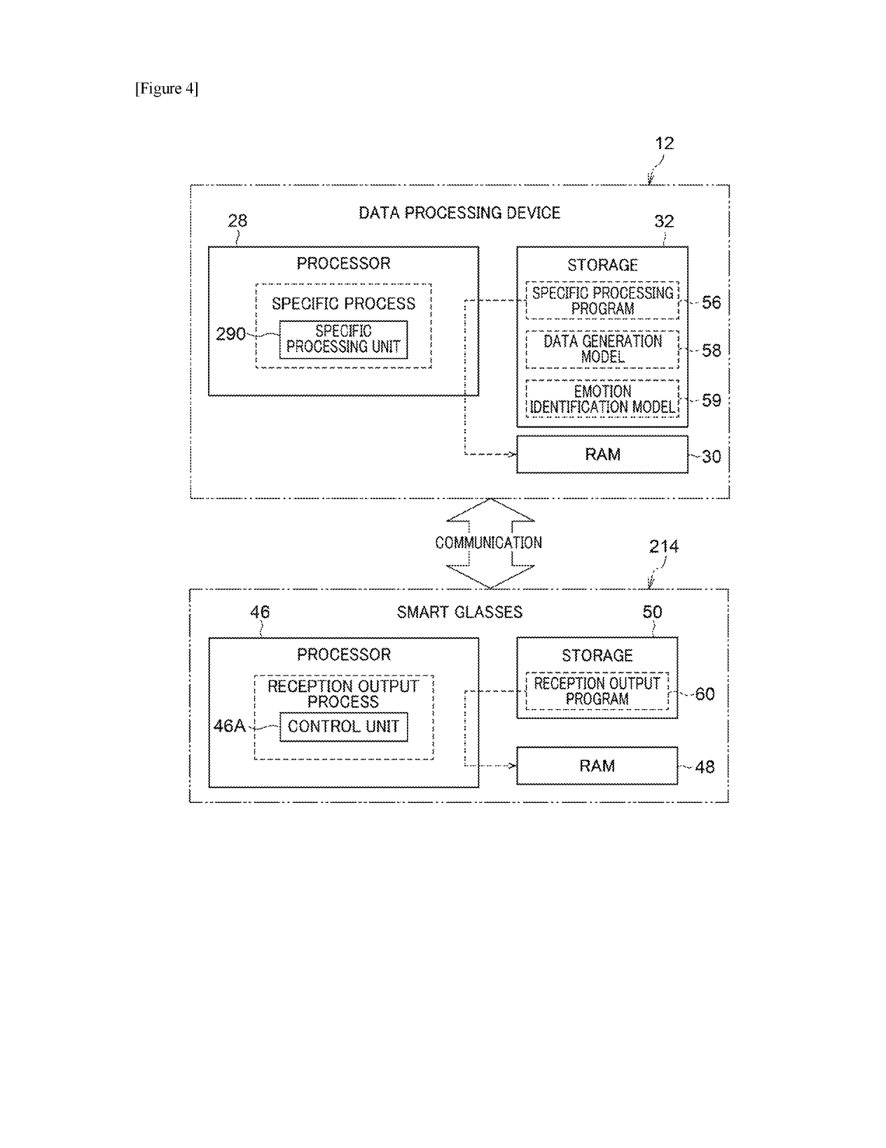

FIG. 4 shows an example of the key functions of the data processing device 12 and the smart glasses 214. As shown in FIG. 4, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

In the smart glasses 214, the processor 46 performs the reception output processing. The reception output program 60 is stored in the storage 50. The processor 46 reads the reception output program 60 from the storage 50 and executes the read reception output program 60 on the RAM 48. The reception output processing is realized by the processor 46 operating as the control unit 46A according to the reception output program 60 executed on the RAM 48. The reception output processing is performed by the processor 46 acting as a control unit 46A according to the reception output program 60 executed on RAM 48. Note that the smart glasses 214 may also have a data generation model 58 and an emotion identification model 59, and can perform processing similar to that of the identification processing unit 290 using these models.

Next, the identification processing performed by the identification processing unit 290 of the data processing device 12 is described. The components of the system described below are implemented by the data processing device 12 and the smart glasses 214. In the following description, the data processing device 12 is referred to as the "server," and the smart glasses 214 are referred to as the "terminal."

### Example 1

The flow of the specific processing in Example 1 described in the first embodiment is the same as described above, so the explanation is omitted.

### Application Example 1

The flow of the specific processing is the same as that described in Example 1 of the first embodiment above; therefore, the description is omitted.

The specific processing unit 290 transmits the result of the specific processing to the smart glasses 214. In the smart glasses 214, the control unit 46A causes the speaker 240 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. The AI may also be an AI agent. Furthermore, when the processing of the aforementioned components is performed by the AI, such processing may be performed in part or in whole by the AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart glasses 214.

### Third Embodiment

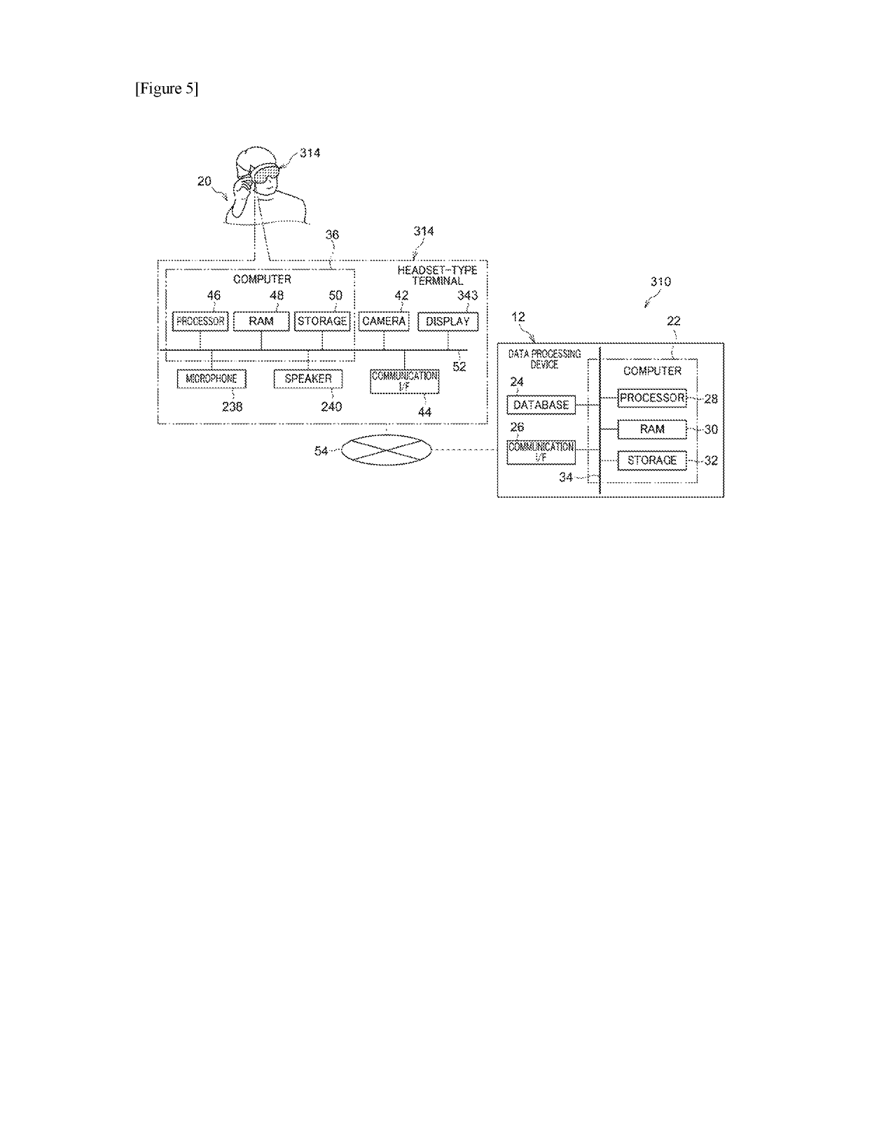

FIG. 5 shows an example configuration of the data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The headset-type terminal 314 includes a computer 36, a microphone 238, a speaker 240, a camera 42, a communication interface 44, and a display 343. The computer 36 includes a processor 46, RAM 48, and storage 50. The processor 46, RAM 48, and storage 50 are connected to a bus 52. Processor 46, RAM 48, and storage 50 are connected to bus 52. Microphone 238, speaker 240, camera 42, and display 343 are also connected to bus 52.

Microphone 238 receives voice input from user 20 to accept instructions and the like. Microphone 238 captures the voice input from user 20, converts the captured voice into audio data, and outputs it to processor 46. Speaker 240 outputs audio according to instructions from processor 46.

Camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

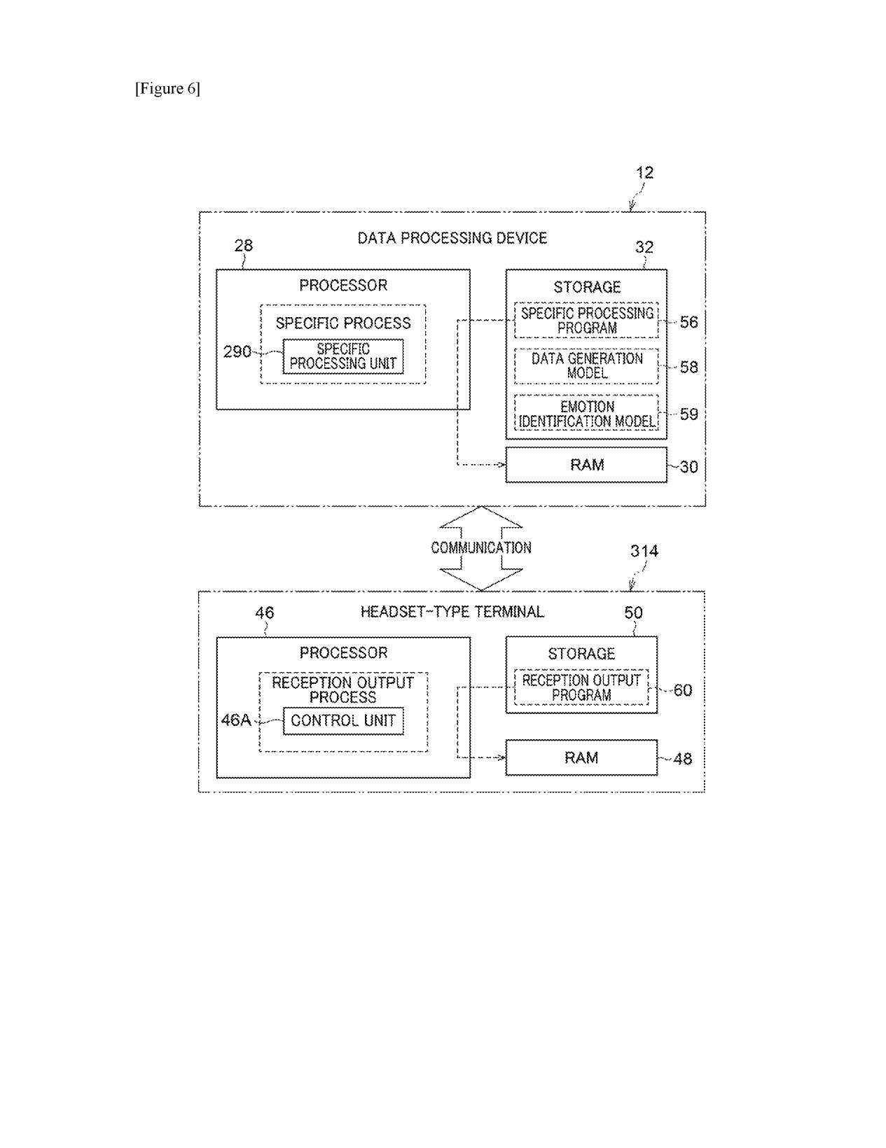

FIG. 6 shows an example of the main functions of the data processing device 12 and the headset-type terminal 314. As shown in FIG. 6, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executed on the RAM 30.

Storage 32 stores a data generation model 58 and an emotion identification model 59. The data generation model 58 and the emotion identification model 59 are used by the specific processing unit 290.

In the headset-type terminal 314, reception output processing is performed by the processor 46. The reception output program 60 is stored in the storage 50. Processor 46 reads the reception output program 60 from storage 50 and executes the read reception output program 60 on RAM 48. Reception output processing is achieved by processor 46 operating as control unit 46A according to the reception output program 60 executed on RAM 48.

Next, the specific processing performed by the specific processing unit 290 of the data processing device 12 is described. The various parts of the system described below are implemented by the data processing device 12 and the headset-type terminal 314. In the following description, the data processing device 12 is referred to as the "server," and the headset-type terminal 314 is referred to as the "terminal."

### Example 1

The flow of the specific processing is the same as that described in Example 1 of the first embodiment, so the description is omitted.

### Application Example 1

The flow of the specific processing in Example 1 described in the first embodiment is the same as above, so the explanation is omitted.

The specific processing unit 290 transmits the result of the specific processing to the headset-type terminal 314. At the headset-type terminal 314, the control unit 46A causes the speaker 240 and the display 343 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., while the smart device 14 acquires or collects information necessary for processing from the data processing device 12 or external devices, etc.

For example, the collection unit is implemented by the control unit 46A of the smart device 14 or the specific processing unit 290 of the data processing device 12. For example, the acquisition unit acquires step count data using the camera 42 or communication I/F 44 of the smart device 14 and is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the headset-type terminal 314.

### Fourth Embodiment

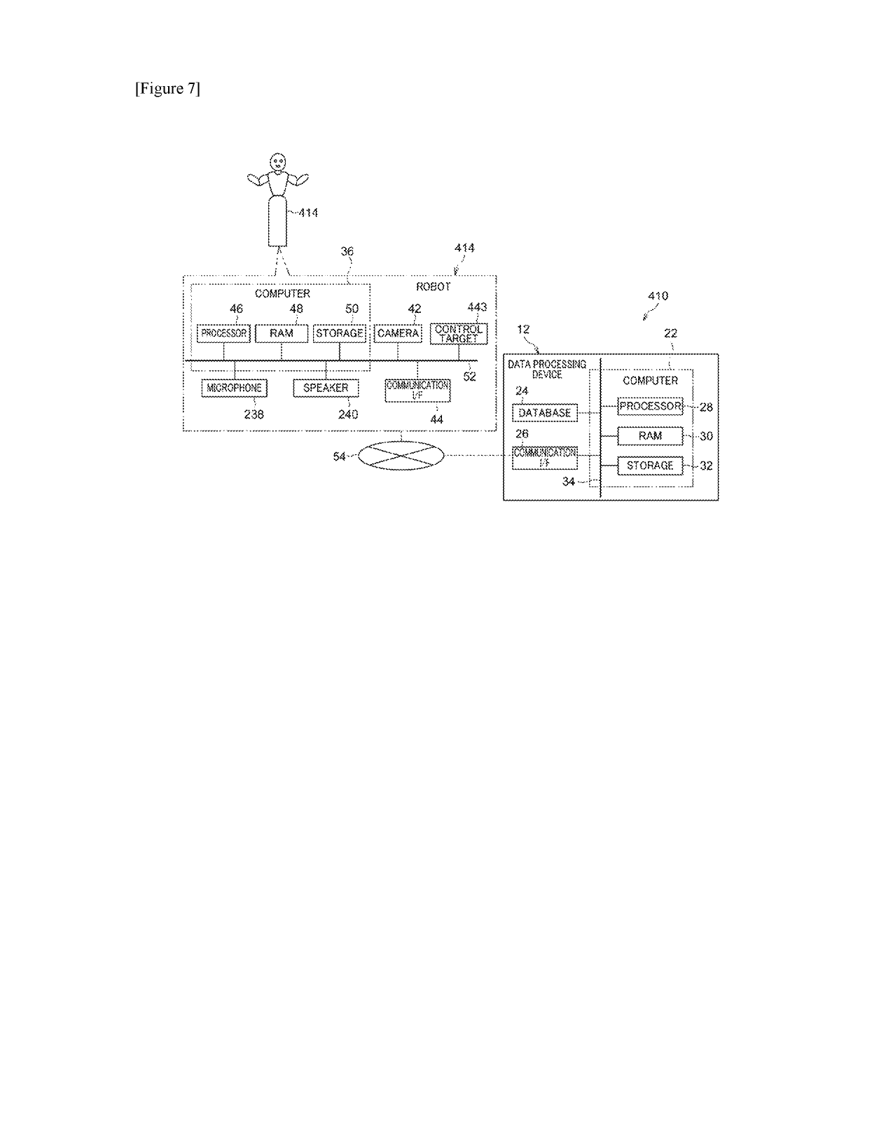

FIG. 7 shows an example configuration of the data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 is an example of a "computer" related to the technology of this disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

Robot 414 includes a computer 36, a microphone 238, a speaker 240, a camera 42, a communication I/F 44, and a control target 443. Computer 36 includes a processor 46, RAM 48, and storage 50. Processor 46, RAM 48, and storage 50 are connected to bus 52. Furthermore, microphone 238, speaker 240, camera 42, and controlled object 443 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

Camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 handle the exchange of various information between processor 46 and processor 28 via network 54. The exchange of various information between processor 46 and processor 28 using communication I/F 44 and 26 is performed in a secure state.

The control target 443 includes a display device, LEDs for the eyes, and motors for driving the arms, hands, legs, etc. The posture and gestures of robot 414 are controlled by controlling the motors for the arms, hands, legs, etc. Part of the robot 414's emotions can be expressed by controlling these motors. Furthermore, the robot 414's facial expressions can also be expressed by controlling the light emission state of the LEDs in its eyes.

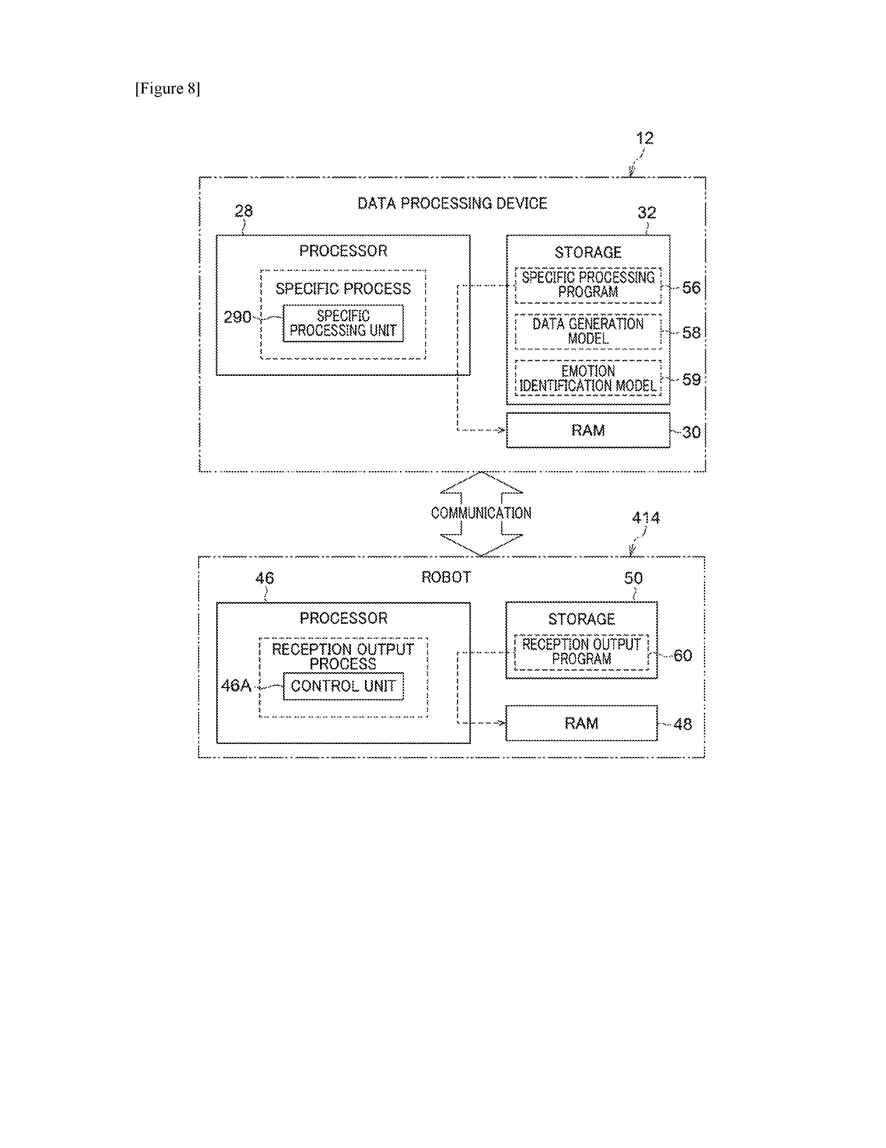

FIG. 8 shows an example of the main functions of the data processing device 12 and the robot 414. As shown in FIG. 8, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by specific processing unit 290.

In robot 414, reception output processing is performed by processor 46. Storage 50 stores a reception output program 60. Processor 46 executes the reception output program 60 stored in storage. Read the reception output program 60 from memory location 50 and execute the read reception output program 60 in RAM 48. The reception output processing is realized by the processor 46 operating as the control unit 46A according to the reception output program 60 executed in RAM 48.

Next, the specific processing performed by the specific processing unit 290 of the data processing device 12 is described. The various parts of the system described below are implemented by the data processing device 12 and the robot 414. In the following description, the data processing device 12 is referred to as the "server," and the robot 414 is referred to as the "terminal."

### Example 1

The flow of the specific processing is the same as that described in Example 1 of the first embodiment, so the description is omitted.

### Application Example 1

The flow of the specific processing in Example 1 described in the above first embodiment is the same, so the explanation is omitted.

The specific processing unit 290 transmits the result of the specific processing to the robot 414. In the robot 414, the control unit 46A causes the speaker 240 and the control target 443 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input prompts containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the acquisition unit is implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the robot 414.

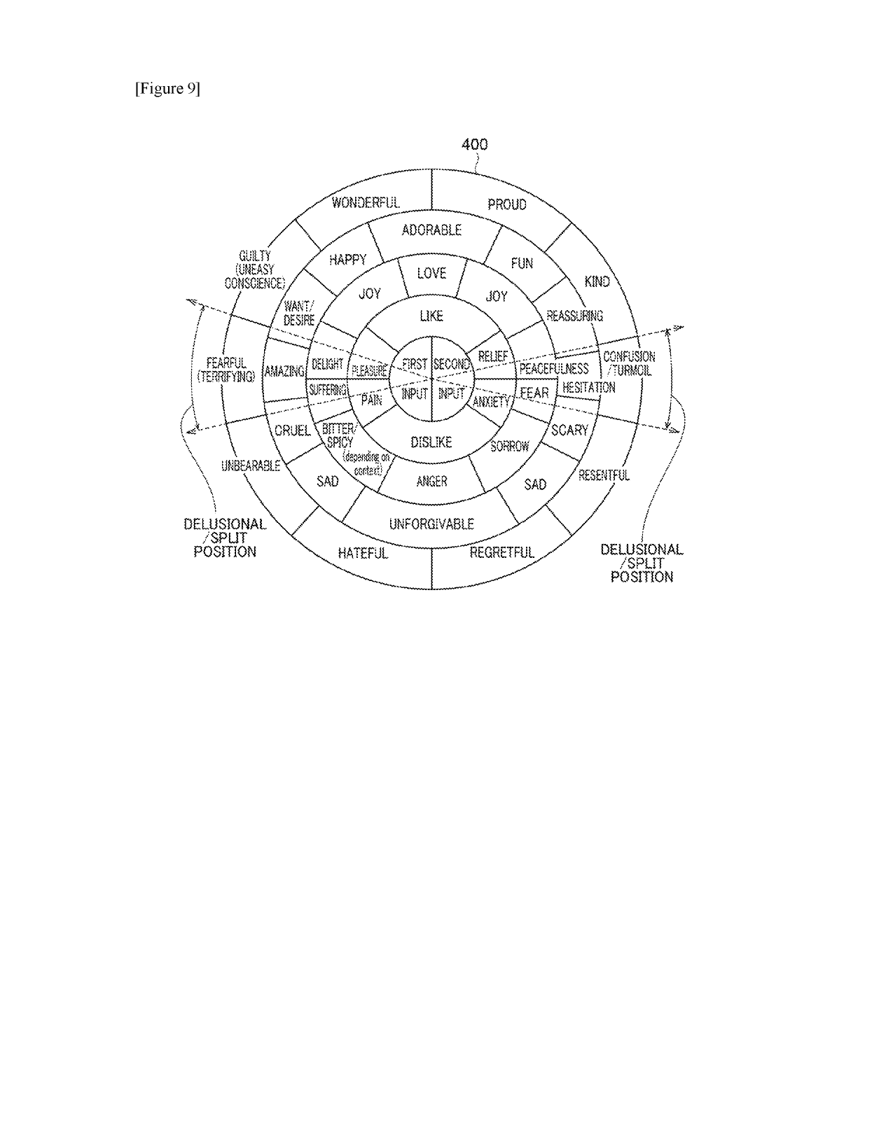

The emotion identification model 59, functioning as an emotion engine, may determine the user's emotion according to a specific mapping. Specifically, the emotion identification model 59 may determine the user's emotion according to an emotion map (see FIG. 9), which is a specific mapping. Furthermore, the emotion identification model 59 may similarly determine the robot's emotion, and the specific processing unit 290 may perform specific processing using the robot's emotion.

FIG. 9 is a diagram showing an emotion map 400 where multiple emotions are mapped. In the emotion map 400, emotions are arranged in concentric circles radiating from the center. Emotions closer to the center of the concentric circles represent more primitive states. Emotions representing states or behaviors arising from mental states are placed further out in the concentric circles. Emotion is a concept encompassing affect and mental states. Generally, emotions generated from reactions occurring within the brain are placed on the left side of the concentric circles. Generally, emotions induced by situational judgment are placed on the right side of the concentric circles. Generally, emotions generated from reactions occurring within the brain and also induced by situational judgment are placed in the upper and lower directions of the concentric circles. Furthermore, the upper part of the concentric circle contains "pleasant" emotions, while the lower part contains "unpleasant" emotions. Thus, the Emotion Map 400 maps multiple emotions based on the structure of their origin, with emotions that tend to occur simultaneously mapped close together.

These emotions are distributed around the 3 o'clock position on Emotion Map 400, typically oscillating between feelings of security and anxiety. In the right half of Emotion Map 400, situational awareness takes precedence over internal sensations, resulting in a calmer impression.

The inner part of the emotion map 400 represents the mind, while the outer part represents behavior. Therefore, the further out on the emotion map 400, the more visible the emotion becomes (manifesting in behavior).

Here, human emotions are based on various balances, such as posture and blood sugar levels. When these balances deviate from the ideal, it indicates a state of discomfort; when they approach the ideal, it indicates a state of comfort. Similarly, for robots, automobiles, motorcycles, etc., emotions can be created based on various balances, such as posture and battery level. When these balances deviate from the ideal, it indicates a state of discomfort; when they approach the ideal, it indicates a state of comfort. Emotion maps, for example, Dr. Mitsuyoshi's Emotion Map (Research on Speech Emotion Recognition and Neurophysiological Signal Analysis of Emotions, Tokushima University, Doctoral Dissertation: https://ci.nii.ac.jp/naid/500000375379). The left half of the emotion map displays emotions belonging to the "Reaction" area, where sensory perception dominates. The right half of the emotion map displays emotions belonging to the "Situation" domain, where situational awareness is dominant.

The emotion map defines two emotions that promote learning. One is the negative emotion around the center of the "repentance" or "reflection" area on the situation side. That is, when the robot experiences negative emotions like "I never want to feel this way again" or "I don't want to be scolded anymore." The other is the positive emotion around "desire" on the reaction side. That is, when the robot feels positive emotions like "I want more" or "I want to know more."

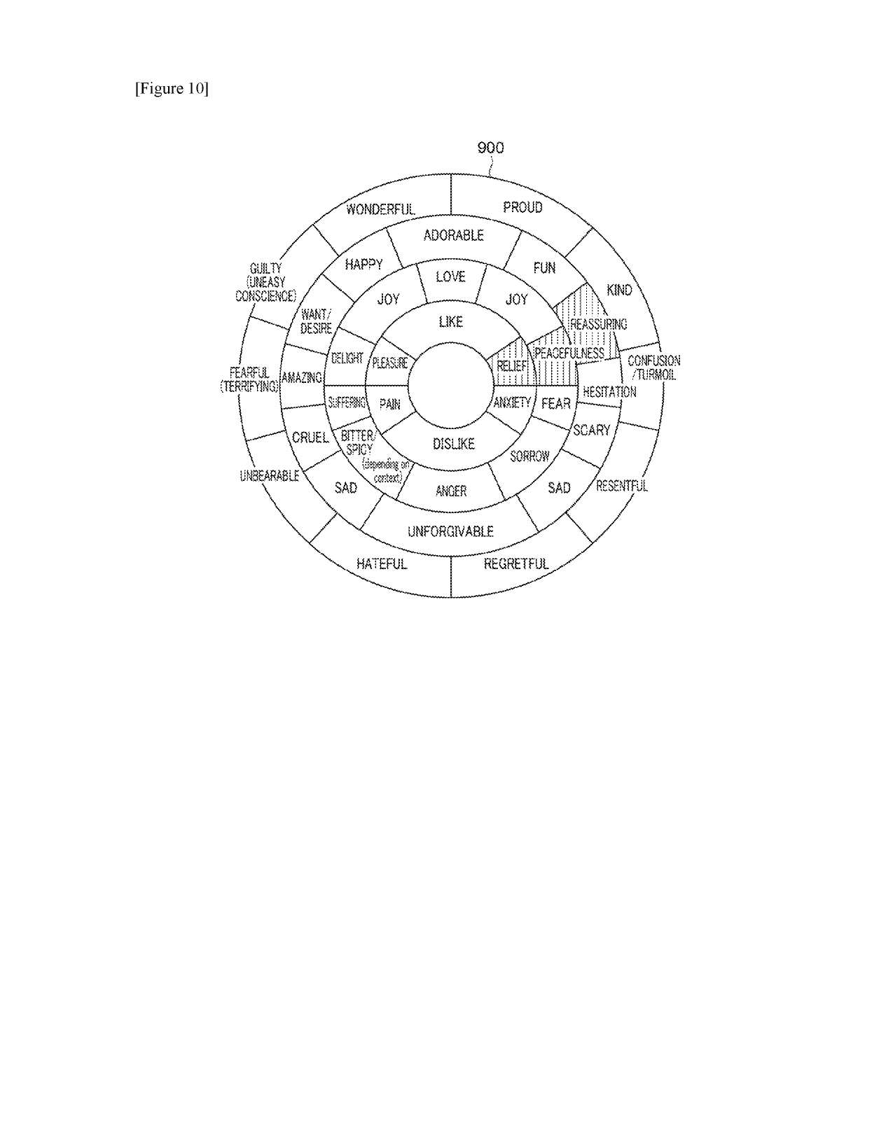

The emotion identification model 59 inputs the user input into a pre-trained neural network, obtains emotion values corresponding to each emotion shown in the emotion map 400, and determines the user's emotion. This neural network is pre-trained based on multiple training data sets, which are combinations of user input and emotion values corresponding to each emotion shown in the emotion map 400. Furthermore, this neural network is trained such that emotions positioned close to each other, as shown in the emotion map 900 in FIG. 10, have similar values. FIG. 10 illustrates an example where multiple emotions, such as "reassurance," "tranquility," and "encouragement," have similar emotion values.

The above description primarily explains the system according to the present disclosure in terms of the functions of the data processing device 12. However, the system according to the present disclosure is not necessarily implemented on a server. The system according to the present disclosure may be implemented as a general information processing system. For example, the present disclosure may be implemented as a software program operating on a personal computer or as an application operating on a smartphone, etc. The method according to the present disclosure may be provided to users in a SaaS (Software as a Service) format.

The above embodiments illustrated a configuration where specific processing is performed by a single computer 22. However, the technology of this disclosure is not limited thereto. Distributed processing may be performed by multiple computers, including computer 22, for specific processing. For example, data generation model 58 may be provided in an external device of data processing device 12, and said external device may generate data corresponding to input data. For example, the data generation model 58 may be provided in an external device of the data processing device 12, and data generation corresponding to input data may be performed in said external device.

The above embodiment described a configuration where a specific processing program 56 is stored in storage 32, but the technology disclosed herein is not limited thereto. For example, the specific processing program 56 may be stored on a portable, computer-readable non-volatile storage medium such as a USB (Universal Serial Bus) memory. The specific processing program 56 stored on the non-volatile storage medium is installed on the computer 22 of the data processing device 12. The processor 28 executes specific processing according to the specific processing program 56.

Alternatively, the specific processing program 56 may be stored on a storage device, such as a server, connected to the data processing device 12 via the network 54. Upon request from the data processing device 12, the specific processing program 56 is downloaded and installed on the computer 22.

It should be noted that it is not necessary to store the entire specific processing program 56 in a storage device such as a server connected to the data processing device 12 via the network 54, or to store the entire specific processing program 56 in the storage 32. It is also possible to store only a portion of the specific processing program 56.

Various types of processors can be used as hardware resources to execute the specific processing. Examples of processors include a CPU, which is a general-purpose processor that functions as a hardware resource to execute specific processing by executing software, i.e., a program Additionally, processors may include dedicated electronic circuits, such as FPGAs (Field-Programmable Gate Array), PLDs (Programmable Logic Device), or ASICs (Application Specific Integrated Circuit), which are processors with circuit configurations specifically designed to execute particular processing tasks. Each processor incorporates or connects to memory, and each processor executes specific processing by utilizing this memory.

The hardware resources for executing specific processing may be comprised of one of these various processors, or may be comprised of a combination of two or more processors of the same or different types (e.g., a combination of multiple FPGAs, or a combination of a CPU and an FPGA). Furthermore, the hardware resources for executing specific processing may be a single processor.

Examples of processors composed of a single unit include: First, a configuration where one processor is formed by combining one or more CPUs with software, functioning as a hardware resource to execute specific processing. Second, a configuration using a processor that implements the entire system's functionality—including multiple hardware resources for executing specific processing—on a single IC chip, as exemplified by System-on-a-chip (SoC). In this manner, specific processing is realized as a hardware resource using one or more of the various processors described above.

Furthermore, regarding the hardware structure of these various processors, more specifically, electrical circuits combining circuit elements such as semiconductor devices can be used. Also, the specific processing described above is merely one example. Therefore, it goes without saying that within the scope not deviating from the main purpose, unnecessary steps may be omitted, new steps may be added, or the processing order may be changed.

The above description and illustrations provide a detailed explanation of the aspects pertaining to the technology of this disclosure and represent merely one example of the technology disclosed herein. For example, the above descriptions of the configuration, functions, actions, and effects are merely examples of the configuration, functions, actions, and effects of the portion pertaining to the technology of the present disclosure. Therefore, it goes without saying that within the scope not deviating from the spirit of the technology of the present disclosure, unnecessary portions may be omitted, new elements may be added, or replacements may be made to the above-described content and illustrated content. Furthermore, to avoid complexity and facilitate understanding of the technical aspects of the present disclosure, descriptions of common technical knowledge and the like that are not particularly necessary for enabling the present disclosure have been omitted from the above descriptions and illustrations.

All literature, patent applications, and technical specifications cited herein are incorporated by reference to the same extent as if each were specifically and individually cited.

The following further discloses the above embodiments.

### Supplementary Note 1

A system comprising a speech recognition unit, a generative AI unit, a speech synthesis unit, and an interaction log recording unit, wherein the speech recognition unit converts voice input from elderly individuals or caregivers into text data in real time, the generative AI unit analyzes the text data to generate solutions based on the user's intent, the speech synthesis unit converts the generated solutions into voice data to respond to the user vocally, characterized in that the interaction log recording unit records the content of the user's inquiry and the response content generated by the generative AI unit.

The system according to Supplementary Note 1, wherein the speech recognition unit is designed to accommodate noisy environments and speech patterns characteristic of elderly individuals, and includes a function to learn the user's accent and speech patterns, thereby improving recognition accuracy over time. This enables accurate speech recognition even in environments such as rooms with televisions on or where multiple people are speaking.

The system described in Supplementary Note 1, wherein the interaction log recording unit automatically records logs containing the user's inquiry content, the response content generated by the generative AI unit, and the voice data generated by the voice synthesis unit, enabling care staff to refer to them later. This allows care staff to develop more effective care plans based on past interactions and provides feedback for improving care quality by analyzing the log data.

### EXPLANATION OF SYMBOLS

10, 210, 310, 410 Data Processing System

12 Data Processing Device

14 Smart Device

214 Smart Glasses

314 Headset-type devices

414 Robot

What is claimed is:

1. A distributed data processing system comprising a terminal device and a server device, the system comprising:
a terminal-side speech recognition unit configured to convert voice input into text data in real time, wherein the unit is configured to iteratively learn a user’s accent and speech patterns to improve transcription accuracy over time;
a server-side generative AI unit configured to analyze the text data to identify a user intent and generate a solution by applying the text data to a prompt template specific to a detected device state;
a server-side speech synthesis unit configured to convert the solution into audio data for output at the terminal; and
an interaction log recording unit configured to analyze historical patterns within a recorded log to predict future technical issues and generate data for proactive countermeasures.

2. The system of claim 1, wherein the speech recognition unit further comprises a function to filter environmental noise specifically associated with moving trains or cafes.

3. The system of claim 1, wherein the generative AI unit builds a knowledge base from past inquiry data to enable rapid responses to recurring issues.

4. The system of claim 1, wherein the server-side speech synthesis unit provides multilingual support for at least English, Chinese, and Spanish.

5. The system of claim 1, wherein the interaction log recording unit is configured to trigger human support staff intervention and present the recorded history of the current session for reference.

6. The system of claim 1, wherein the prompt template used by the generative AI unit is selected from a group consisting of a screen freeze template and a battery drain template.

7. A system for providing health management support in a care environment, comprising:
a speech recognition unit configured to convert voice input into text data, wherein the unit is specialized to accurately transcribe speech patterns characteristic of elderly individuals in noisy environments;
an emotion identification model configured to estimate a user’s emotional state by mapping user input values onto a concentric emotion map, where emotions closer to the center represent primitive mental states and emotions further out represent behavioral manifestations;
a generative AI unit configured to generate a solution response based on the text data and a pre-registered health or medication schedule; and
a speech synthesis unit configured to adjust vocal tone and speed of the response based on the emotional state derived from the concentric emotion map.

8. The system of claim 7, wherein the generative AI unit is further configured to generate a notification to medical staff upon identifying a report of high body temperature.

9. The system of claim 7, wherein the emotion identification model utilizes a neural network trained to assign similar emotion values to emotions positioned close together on the concentric map.

10. The system of claim 7, wherein the speech recognition unit is configured to interpret ambiguous expressions by analyzing the context of the care environment.

11. The system of claim 7, wherein the interaction log is formatted to allow care staff to develop care plans based on the recorded history of user inquiries and emotional states.

12. The system of claim 7, wherein the speech synthesis unit allows the user to manually adjust voice preferences to further personalize the interaction.

13. An apparatus comprising a processor and a memory storing instructions that, when executed by the processor, cause the apparatus to:
transcribe user speech into text data while performing context-aware filtering of environmental noise;
identify a user intent by processing the text data through a generative AI model that references a learned knowledge base of past inquiry data;
estimate a user emotion by inputting the text data into a neural network trained to assign values based on an emotion map where "pleasant" and "unpleasant" emotions are mapped in opposing directions; and
execute a physical output via a robot control unit, wherein the output comprises a gesture or a change in LED eye state selected to correspond to the estimated user emotion.

14. The apparatus of claim 13, wherein the physical output includes controlling motors in at least one of an arm, a hand, or a leg to express a robotic emotion.

15. The apparatus of claim 13, wherein the instructions further cause the apparatus to estimate a robotic emotional state based on a current battery level of the apparatus.

16. The apparatus of claim 13, wherein the generative AI model is a fine-tuned model capable of outputting results from prompts that do not contain explicit instructions.

17. The apparatus of claim 13, wherein the processor is further configured to transmit user feedback regarding the results of the specific processing back to a data processing device to update the interaction log.

18. The apparatus of claim 13, wherein the instructions cause the apparatus to switch between AI-based and rule-based processing for generating solutions based on the complexity of the user intent.
